(19) United States
(12) Patent Application Publication
(10) Pub. No.: US 2008/0227553 A1
(43) Pub. Date: Sep. 18, 2008

(54) AUTOMATIC CREATION OF PERSONAL PLAYER WEB PAGES AND FEED OF PERSONAL DATA AND GAME CONTENT TO THE PAGES

(76) Inventors: Yaron Leifenberg, Rishon Lezion (IL); Ilan Gracier, Tel Aviv (IL)

Correspondence Address: Naomi Assia Law Offices;C/O Landon IP Inc., Suite 450, 1700 Diagonal Road, Alexandria, VA, 22314, US

(21) Appl. No.: 12/046,607

(22) Filed: Mar. 12, 2008

Related U.S. Application Data
(60) Provisional application No. 60/894,251, filed on Mar. 12, 2007.

(51) Int. Cl. G06F 17/00

(52) U.S. Cl. 463/42

(57) ABSTRACT

A system for automatic creation of a personal Web page of an online game player and feed of personal data and game content to the pages for each of a plurality of game players. The system includes a game server. The system also includes a game client configured as an application on an electronic game playing device of the player and automatically generated personal Web pages for each of the plurality of game players, wherein the application sends the personal data and the game content over an electronic network to the game server, such that a personal Web page comprising the personal data and game content of a game currently being played by each of the plurality of game players is generated online and is accessible to each corresponding player.

### CROSS-REFERENCE TO RELATED APPLICATION

This application claims priority from U.S. Provisional Patent Application No. 60/894,251, filed Mar. 12, 2007, which is hereby incorporated by reference in its entirety.

### FIELD OF THE INVENTION

The present invention generally relates to video games, and more particularly the present invention relates to a method and a system for automatic creation of personal player Web pages and feed of personal data and game content to the pages.

### BACKGROUND OF THE INVENTION

Online games are played over a computer network. At the present, this almost always means the Internet. The expansion of online gaming has reflected the overall expansion of computer networks from small local networks to the Internet and the growth of Internet access itself. Online games can range from simple text based games to games incorporating complex graphics and virtual worlds populated by many players simultaneously. Many online games have associated online communities, making online games a form of social activity beyond single player games.

In early networking and timesharing environments video games were often among their most admired features. The CDC Plato system's game gallery was famous, as was Maze War at Xerox PARC. When personal computers reached the general public in the 1980s, simple multiplayer text-based games, Multi-user dungeons (MUD's), were often played on Bulletin Board Systems (BBS's) using a modem. These games were frequently based on fantasy settings, using rules similar to those in the role-playing game Dungeons & Dragons. Other styles of games, such as chess, Scrabble clones, and other board games were available. Since continuous connectivity was often expensive, as access was frequently charged on a per-minute basis, some games were set up as play-by-email games.

The rising popularity of Flash and Java led to an Internet revolution where Websites could utilize streaming video, audio and a whole new set of user interactivity. When Microsoft began packaging Flash as a pre-installed component of Internet Explorer, the Internet began to shift from a data/information spectrum to offer on-demand entertainment. This revolution paved the way for sites to offer games to Web surfers. Most online games like World Of Warcraft, Final Fantasy XI and Lineage II charge a monthly fee to subscribe to their services, while games such as Guild Wars offer an alternative no-monthly-fee scheme. Many other sites relied on advertising revenues from on-site sponsors, while others, like RuneScape, let people play for free while leaving the players the option of paying, thereby unlocking new content for the members.

Many sites solely relying on advertising revenue dollars in 2001 after the dot-com bubble burst, faced extreme adversity. Despite the decreasing profitability of online gaming Websites, some sites offset the advertising revenue loss by using the content as a cross-promotion tool for driving Web visitors to other Websites that the company owns.

### DEFINITIONS

A Web hosting service allows individuals and organizations to provide their own Websites accessible via the Internet. Web hosts are companies that provide space on a server they own for use by their clients as well as providing Internet connectivity, typically in a data center. Web hosts can also provide data center space and connectivity to the Internet for servers they do not own, but located in their data center, called colocation

An online identity is a social identity that network users establish in online communities. Although some people prefer to use their real names online, most Internet users prefer to identify themselves by means of pseudonyms, which reveal varying amounts of personally identifiable information. In some online game contexts, users can represent themselves visually by choosing an avatar, an icon-sized graphic image. As other users interact with an established online identity, it acquires a reputation, which enables them to decide whether the identity is worthy of trust.

Thus, it would be advantageous to provide a more player oriented Web presence to facilitate and enhance the online game experience for online game players.

### SUMMARY OF THE INVENTION

Accordingly, it is a principal object of the present invention to provide a computer game system that can be played on any platform, such as a personal computer (PC)/game console/cellular phone/interactive TV/hand held device, etc.

It is one other principal object of the present invention to provide a more player oriented Web presence to facilitate and enhance the online game experience for online game players.

It is another principal object of the present invention to create an automatic Web page for any player that plays the game.

A system is disclosed for automatic creation of a personal Web page of an online game player and feed of personal data and game content to the pages for each of a plurality of game players. The system includes a game server. The system also includes a game client configured as an application on an electronic game playing device of the player and automatically generated personal Web pages for each of the plurality of game players, wherein the application sends the personal data and the game content over an electronic network to the game server, such that a personal Web page comprising the personal data and game content of a game currently being played by each of the plurality of game players is generated online and is accessible to each corresponding player.

The Web page holds dynamic data from the game and includes any of the players/character/team/assets data, such as attributes, digital assets, description, etc. The game system also generates game related content, such as pictures, automatically generated comic strips, videos from the game, audio and text and sends it to the Web page to be published.

The Web pages are either created as a part of an independent Web host or as a part of a central Web site, that also includes a social network related to the game, and includes social tools, such as search of players by features and buddy lists/forums/chat/messaging that is accessible both from the Website and the game itself.

There has thus been outlined, rather broadly, the more important features of the invention in order that the drawing thereof that follows hereinafter may be better understood. Additional details and advantages of the invention will be set forth, and in part will be appreciated from the brief description, or may be learned by practice of the invention.

### BRIEF DESCRIPTION OF THE DRAWING

In order to understand the invention and to see how it may be carried out in practice, a preferred embodiment will now be described, by way of a non-limiting example only, with reference to the accompanying drawing, in which:

FIG. 1 is a schematic block diagram of the system for automatic creation of personal player Web pages and feeding of personal data and game content to the pages of the present invention; and

FIG. 2 is a detailed schematic illustration of personal Web page of the player, constructed according to the principles of the present invention.

### DETAILED DESCRIPTION OF A PREFERRED EMBODIMENT

The principles and operation of a method and an apparatus according to the present invention may be better understood with reference to the drawings and the accompanying description, it being understood that these drawings are given for illustrative purposes only and are not meant to be limiting.

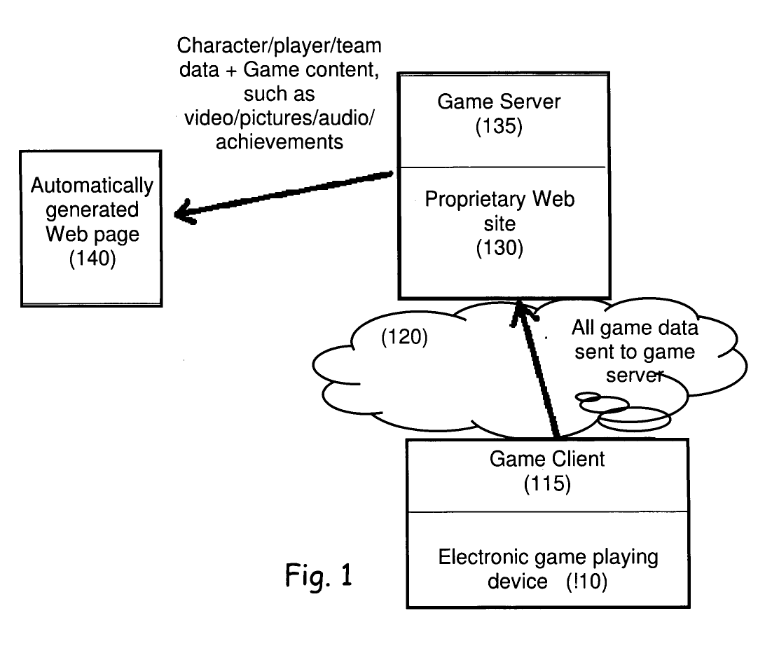

FIG. 1 is a schematic block diagram of the system for automatic creation of personal player Web pages and feeding of personal data and game content to the pages of the present invention. On the client side a game client application 115 residing on an electronic game playing device 110 of a player, such as a personal computer, a mobile phone, a lap top computer, etc, sends all data over the Internet 120 to a game server 135 located, preferably but not necessarily, at a proprietary Web site 130 of the present invention. Game server 135 then retransmits the data, including character/player/team data plus game content such as video/pictures/audio/achievements to an automatically generated personal Web page 140 of the player.

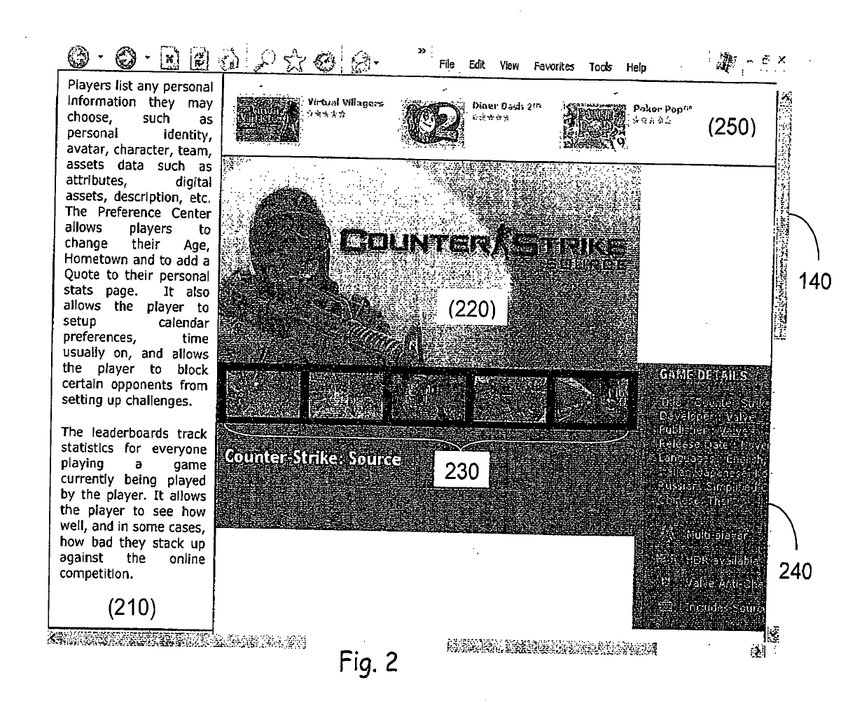

FIG. 2 is a detailed schematic illustration of personal Web page 140 of the player, constructed according to the principles of the present invention. Players list any personal information 210 they may choose, such as personal identity, avatar, character, team, assets data such as attributes, digital assets, description, etc. A preference editing option allows players to change their age, hometown or add a Quote to their personal stats page, for example. It also allows the player to setup calendar preferences, time usually on, and allows the player to block certain opponents from setting up challenges.

A leader-board is provided to track statistics for everyone playing the game currently being played by the player. It allows the player to see how well, and in some cases, how bad he stacks up against the online competition. Personal Web page 140 also shows a game cover image 220 and several pictures from the game 230. These pictures may also be in cartoon storyboard format. The game details 240 are also shown. There may also be a selection 250 or scrollable list of the player's favorite games.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A system for automatic creation of a personal Web page of an online game player and feed of personal data and game content to the pages for each of a plurality of game players, the system comprising:
a game server;
a game client configured as an application on an electronic game playing device of the player; and
automatically generated personal Web pages for each of the plurality of game players,
wherein said application sends the personal data and the game content over an electronic network to said game server, such that a personal Web page comprising the personal data and game content of a game currently being played by each of the plurality of game players is generated online and is accessible to each corresponding player.

2. The system of claim 1, wherein said electronic game playing device is a personal computer.

3. The system of claim 1, wherein said electronic game playing device is a mobile phone.

4. The system of claim 1, wherein said electronic game playing device is a laptop computer.

5. The system of claim 1, wherein said electronic network is the Internet.

6. The system of claim 1, wherein said game server is located at a proprietary Website.

7. A method for automatic creation of a personal Web page of an online game player and feed of personal data and game content to the pages for each of a plurality of game players, by a system comprising:
a game server;
a game client configured as an application on an electronic game playing device of the player; and
automatically generated personal Web pages for each of the plurality of game players,
said method comprising:
sending the personal data and game content over an electronic network to said game server; and
retransmitting by said data game server of the personal data and game content to an automatically generated personal Web page of the player,
such that a personal Web page comprising the personal data and game content of a game currently being played by each of the plurality of game players is generated online and is accessible to each corresponding player.

8. The method of claim 7, wherein said electronic network is the Internet.

9. The method of claim 7, wherein said personal data comprises at least one of character, player and team data,

10. The method of claim 7, wherein said game content comprises at least one of video, pictures, cartoon strips, audio personal achievements and team achievements.
